(19) United States
(12) Patent Application Publication
(10) Pub. No.: US 2023/0361419 A1
(43) Pub. Date: Nov. 9, 2023

(54) BATTERY CELL CLOSURE STRIP FOR A BATTERY CELL OF PRISMATIC OR OF POUCH-TYPE DESIGN, AND BATTERY CELL

(71) Applicant: Gerd Schollenberger, Sersheim (DE)

(72) Inventor: Gerd Schollenberger, Sersheim (DE)

(21) Appl. No.: 18/313,874

(22) Filed: May 8, 2023

Related U.S. Application Data
(63) Continuation of application No. PCT/EP2021/080165, filed on Oct. 29, 2021.

(30) Foreign Application Priority Data
Nov. 10, 2020 (DE) 10 2020 214 132.0

(51) Int. Cl. H01M 50/342; H01M 50/105; H01M 50/367; H01M 50/184; H01M 50/186; H01M 50/645; H01M 50/121; H01M 50/119

(52) U.S. Cl. CPC H01M 50/3425; H01M 50/105; H01M 50/367; H01M 50/184; H01M 50/186; H01M 50/645; H01M 50/121; H01M 50/119; H01M 2200/20; H01M 2220/20

(57) ABSTRACT

A battery cell closure strip for a battery cell of prismatic or of pouch-type design is disclosed. A main body has a degassing duct which extends along the vertical axis of the battery cell closure strip from an inner side of the battery cell closure strip to the outer side of the battery cell closure strip. The degassing duct is closed by means of a media-operated sealing element during regular operation of the battery cell closure strip. The sealing element opens the degassing duct when a predefined limit pressure of the battery cell is reached. An emergency degassing duct has an opening cross section through which media can flow that is at least 10 times larger than that of the degassing duct and which is closed by a bursting valve which opens the emergency degassing duct when a bursting pressure is reached or exceeded.

### CROSS-REFERENCE TO RELATED APPLICATION

This application claims priority to International application number PCT/EP2021/080165 filed on Oct. 29, 2021 which published as WO 2022/101035 A1, and the German application number 10 2020 214 132.0 filed on Nov. 10, 2020, the entire contents of which are fully incorporated herein with these references.

### DESCRIPTION

### Field of the Invention

The invention relates to a battery cell closure strip for a battery cell of prismatic or of pouch-type design and to a battery cell.

### Background of the Invention

Traction batteries for electric vehicles consist nowadays of a large number of lithium battery cells. Such battery cells are increasingly being manufactured in the form of so-called prismatic battery cells and in the form of pouch battery cells, especially since these designs have the most economically interesting development potential. These designs are characterized by low mass and favorable manufacturing costs. A typical traction battery with an output voltage of 800 V thus comprises at least 1216 cells at a cell voltage of 3.7 V.

The lithium battery cells are the smallest components of a traction battery and are wearing parts and represent potential sources of danger during operation of the electric vehicles. In contrast to round cells which are enclosed by rigid metal housings, or to a certain extent also to prismatic cells, pouch cells cannot compensate for any significant pressure buildup. Even relatively low internal pressures cause the very thin aluminum-thermoplastic composite casing to inflate.

During the manufacturing process of lithium cells, this effect has to be taken into account first of all in terms of process technology. During formatting and pre-aging, referred to as “aging” in technical terms, a relevant amount of gas is firstly formed. In the conventional production of pouch cells, this gas is pressed into a gas bag, which is mechanically separated at the end of this process step.

Due to the particular design, however, undesirable gas formation occurs inside the lithium battery cell also during regular operation. If the temperatures inside the battery cell rise to >40° C. during charging or discharging, the internal pressure can increase due to gas formation in the cell. Even relatively low internal pressure conditions cause the very thin envelope of the pouch cells, made of an aluminum-thermoplastic composite, to inflate. The stiffness of prismatic cells is also nowhere near as high as that of round cells, so that even this type of construction can easily bulge at pressures >1 bar.

For the aforementioned reasons, a so-called degassing valve is often used in lithium battery cells, by which the gas can escape from the battery cell into the environment. Such a degassing valve is known, for example, from PCT/DE98/02218.

In extreme cases, the use of lithium battery cells can also lead to a so-called “thermal runaway”, in which the battery cell becomes very hot very quickly when a temperature limit is exceeded, and a temperature of several hundred degrees can be unstoppably reached within milliseconds. The heat triggers a chemical reaction inside the cell, which releases partially combustible and toxic gases, such as CO2, methane (CH4), hydrofluoric acid (HF), hydrogen (H2), nitrogen oxides NOx, N2O, other hydrocarbons (ethenes, ethynes, benzenes, etc.) and oxygen. The battery cell catches fire or explodes. Possible causes are an internal or external short circuit and excessive currents during charging/discharging. If further battery cells of the traction battery subsequently ignite sequentially, this can lead to a total loss of the vehicle and endanger human life, as known.

### SUMMARY OF THE INVENTION

It is therefore the object of the invention to specify a battery cell closure strip for battery cells of prismatic or pouch-type design, as well as a battery cell of such design, which enables safer operation of the battery cells, in particular in the context of electromobility.

The object is achieved in relation to the battery cell closure strip by a battery cell closure strip having the features indicated in claim 1. A battery cell according to the invention is also indicated in an additional claim.

The battery cell closure strip according to the invention is particularly suitable for a battery cell of prismatic or pouch-type design. The battery cell closure strip serves as a part of the housing of the individual battery cell and is gas-tightly bondable, gas-tightly weldable or otherwise gas-tightly connectable to the rest of the housing of the battery cell. According to the invention, the battery cell closure strip comprises a main body with a degassing duct extending along the vertical axis of the battery cell closure strip from an inner side of the battery cell closure strip to an outer side of the battery cell closure strip. The vertical axis of the battery cell closure strip is oriented vertically when the battery cell closure strip is in use. The degassing duct is closed during regular operation of the battery cell closure strip by means of a media-operated sealing element, which opens the degassing duct only when a predefined atmospheric response pressure or limit pressure Pₗᵢₘ is reached or exceeded in the battery cell. The limit pressure Pₗᵢₘ can be, for example, between 80 and 120 mbar above ambient atmospheric pressure. The battery cell closure strip also comprises an emergency degassing duct which, compared to the degassing duct, has an opening cross section through which media can pass that is at least 10 times larger than that of the degassing duct and which is closed by means of a bursting valve which opens the emergency degassing duct, preferably in the upward direction along the vertical axis, when a predefined (nominal) bursting pressure P_{crit}, where P_{crit}>Pₗᵢₘ, is reached or exceeded.

The battery cell closure strip thus ensures degassing of the battery cell fitted with the battery closure strip in the event of unavoidable internal gas formation. During regular operation, the sealing element efficiently prevents the undesired penetration of gases and moisture, which could impair the capacity of the battery cells or even damage or destroy the same.

The bursting valve includes a so-called bursting membrane. A particularly precise response behavior of the bursting valve can be achieved by such a bursting membrane. Such bursting membranes are also available on the market at low cost and are easy to mount on the base body.

In the event of a massive increase in pressure up to or above the bursting pressure of the bursting valve, associated with the thermal runaway, abrupt degassing of the battery cell in the upward direction of the vertical axis is enabled. In the event of a jet flame, this is also discharged in an upward direction via the battery cell closure strip. Overall, this can counteract the risk of sequential damage and ignition of adjacently arranged battery cells of the respective traction battery. Overall, this can make the operation of the battery cells safer even in the event of a thermal runaway. The activation pressure of the bursting valve can be equal to 1.5 bar, for example.

According to a preferred further embodiment of the invention, the bursting valve comprises a bursting cap. In the present application, a bursting cap is understood to be a cap which is blown off from its sealing seat on the battery closure strip when the bursting valve is activated; such bursting caps can be bonded or welded to the main body of the battery cell closure strip or held with a press fit on the battery cell closure strip.

According to the invention, the bursting cap may be made of a rubber-elastically deformable material. In this case, the bursting cap is preferably arranged with a press fit in or on the battery closure strip. According to the invention, the bursting cap can be arranged in particular on a retaining flange of the main body and surround it circumferentially, preferably on both sides. This simplifies assembly of the battery closure strip and enables reliable sealing of the emergency degassing opening while still ensuring sufficiently safe response of the bursting valve.

According to a preferred embodiment of the invention, a cutting element, in particular a pneumatically actuated cutting piston, is movably mounted on the main body of the battery cell closure strip. By means of the cutting element, the bursting membrane can be perforated particularly reliably when the battery cell closure strip is in use and when a predetermined internal (nominal) bursting pressure P_{crit} is reached. In particular, the cutting element can be made of plastic or the same material as the rest of the main body. The cutting element is preferably displaceably mounted on the main body in a translational manner.

According to the invention, the sealing element preferably has a preferably circumferential sealing lip which, in a sealing position closing the degassing duct on a sealing surface of the battery cell closure strip, can be moved into an open position opening the degassing duct, in which the sealing lip is arranged at least in portions at a distance from the sealing surface of the battery cell closure strip. Such sealing elements are sufficiently well known and exhibit good response behavior to pressure changes.

The sealing element is preferably held in a seal retaining structure, in particular in the form of a recess, of the battery cell closure strip. The seal retaining structure is preferably formed on an extension of the main body, which extends away from the rest of the main body in an axial direction with respect to the vertical axis of the battery cell closure strip. The seal retaining structure and thus the sealing element can thus be spaced from the bursting valve, whereby a particularly compact design of the battery cell closure element in terms of width and depth can be achieved. This is advantageous in view of the very limited installation space present in mobility applications. The bursting valve and the sealing element are thus preferably offset relative to one another in the direction of the vertical axis.

According to the invention, the seal retaining structure can be designed in particular as a recess in the main body, which recess extends transversely, preferably orthogonally, to the vertical axis of the battery cell closure strip. This enables a particularly flat design of the battery cell closure strip. This is particularly advantageous for pouch battery cells.

Very preferably, the battery cell closure strip has the terminals or passageways for the terminals, i.e. the electrical pole contact pins or lugs, of the battery cell. The battery cell closure strip can be used to reliably guide, route and seal the terminals. The terminals can, for example, be bonded to the main body or held embedded in the material of the main body in a gas-tight manner without the use of further adhesive. This can simplify assembly of the battery cell.

Particularly preferably, the battery cell closure strip has a filling opening for the battery cell which opening can be closed by means of a sealing element, in particular a conical or cylindrical plug, which is preferably mounted on the battery cell closure strip. In this way, the filling of the battery cell can be simplified, in particular also automated. The main body of the battery cell closure strip can be made of a plastic material, in particular a thermoplastic material. This makes it possible to manufacture the battery closure strip in a cost-effective manner. It is also easier to recycle it into the material cycle.

A first battery cell according to the invention is provided as a prismatic or a pouch battery cell, the housing of which comprises a battery cell closure strip according to one of the preceding claims. In particular, the battery cell may be a lithium battery cell and is particularly suitable for a traction battery of an electric vehicle. It is understood that, in the installed state, the battery cell has the battery cell closure strip on its upper side in the vertical direction.

Another battery cell, according to the invention, comprising a prismatic housing is characterized in that the housing is closed at the top by means of a battery cell closure strip, the battery closure strip having a main body with a degassing duct which extends from an inner side of the battery cell closure strip to the outer side of the battery cell closure strip, the degassing duct being closed during regular operation of the battery cell closure strip by means of a media-operated sealing element which opens the degassing duct when a predefined limit pressure Pₗᵢₘ is reached or exceeded in the battery cell, and wherein, when a critical bursting pressure P_{crit}, where P_{crit}>Pₗᵢₘ, is reached or exceeded in the battery cell, the battery cell closure strip is separated, in particular completely ejected, from the rest of the housing in order to enable emergency degassing of the battery cell. In other words, by separating the battery closure strip, an emergency degassing duct is created. The emergency degassing opening or the emergency degassing duct preferably has an opening cross section A1 through which media can flow, that is at least 10 times larger than that of the degassing duct.

The battery closure strip and its attachment to the rest of the battery cell housing, which act as a predetermined breaking point, enable directional degassing and, if necessary, upward flame formation along the vertical axis.

Further advantages of the invention can be found in the description and in the figures. Likewise, the above-mentioned and the further features can be used according to the invention in each case individually or as a plurality in any desired combination. The embodiments shown and described are not to be understood as a conclusive list, but rather have an exemplary character in the context of the description of the invention.

### BRIEF DESCRIPTION OF THE DRAWINGS

In the figures:

FIG. 1 shows a first embodiment of a battery closure strip according to the invention with an integrated degassing duct and an emergency degassing duct in a perspective view;

FIG. 2 shows an enlarged detail portion of the battery closure strip according to FIG. 1 in the region of the degassing duct with the sealing element removed;

FIG. 3 shows the battery closure strip according to FIG. 1 in a detail view of the media-operated sealing element of the degassing duct;

FIG. 4 shows a further embodiment of a battery closure strip in which the bursting valve of the emergency degassing duct and the sealing element of the degassing duct are arranged offset from one another in an axial direction with respect to the vertical axis of the battery closure strip;

FIG. 5 shows the battery closure strip according to FIG. 4 in a schematic sectional view;

FIG. 6 shows a further exemplary embodiment of a battery closure strip in which the emergency degassing duct is closed by means of a bursting membrane, the terminals being firmly connected to the main body of the battery cell closure strip;

FIG. 7 shows a further embodiment of a battery closure strip in which the emergency degassing duct is closed by means of a bursting membrane;

FIG. 8 shows a prismatic battery cell (without contents) with a battery closure line comprising a cutting piston for pressure-controlled perforation of the bursting membrane, in a sectional view; and

FIGS. 9a, 9b show a pouch-type battery cell (FIG. 9a) with a battery closure line comprising a degassing duct according to any of the preceding FIGS. 1 to 8 and which is separable/ejectable from the rest of the battery cell housing when reaching/exceeding a bursting pressure P_{crit} (FIG. 9b).

### DETAILED DESCRIPTION OF THE PREFERRED EMBODIMENTS

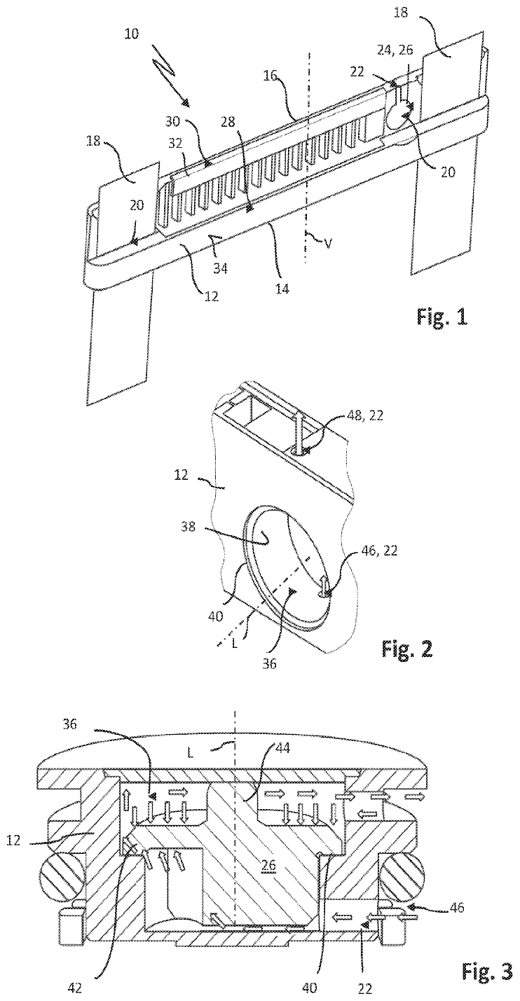

FIG. 1 shows a first embodiment of a battery closure strip 10 for a battery cell in prismatic or pouch-type design. Due to their compact, lightweight design, such battery cells are used in particular for traction batteries in electric vehicles, but have the disadvantage of a housing that is not very stable under pressure with respect to gas generation inside the battery cell.

The battery closure strip 10 has a main body 12 with an inner side 14 and with an outer side 16. in the mounted state, the inner side 14 faces the interior of the housing of the battery cell. The battery closure strip 10 may comprise the terminals 18, i.e. the electrical battery poles of the battery cell, or at least be provided with a through recess 20 for the terminals 18. In the first case, the terminals 18 may be embedded, glued or otherwise sealingly retained in the material of the main body 12.

The battery closure strip 10 comprises a degassing duct 22 extending along the vertical axis V of the battery closure strip 10 from the inner side 14 to the outer side 16 of the battery closure strip 10. The degassing duct 22 is provided with a valve 24 having a media-operated sealing element 26. During regular operation of the battery cell closure strip 10, the degassing duct 22 is closed in a gas-tight manner by means of the sealing element 26. When a predefined limit pressure Pₗᵢₘ of the battery cell acting on the inside of the sealing element 26 is reached or exceeded, deformation of the sealing element 26 is caused in such a way that the sealing element 26 fluidically opens the degassing duct 22, thus enabling degassing of the battery cell. The response pressure or limit pressure Pₗᵢₘ of the sealing element 26 can be 0.1 bar (above atmospheric pressure), for example.

In the event of massive gas generation within the battery cell, such as during thermal runaway, no sufficiently rapid atmospheric pressure equalization is possible via the degassing duct 22. The battery cell closure strip 10 therefore additionally comprises an emergency degassing duct 28. In other words, the emergency degassing duct 28 is formed separately from the degassing duct 22 in the main body 12. The emergency degassing duct 28 is closed in a gas-tight manner by means of a bursting valve 30. The bursting valve 30 is designed in such a way that it opens the emergency degassing duct 28 when a bursting pressure P_{crit} acting on the inside of the bursting valve 30 is reached or exceeded, where P_{crit}>Pₗᵢₘ. The bursting pressure P_{crit} can be equal to 1.5 bar, for example. The emergency degassing duct 28 has an opening cross section through which media can flow that is at least 10 times larger than that of the degassing duct 22. According to FIG. 1, the bursting valve 30 can comprise or be formed of a bursting cap 32. The bursting cap 32 is preferably made of plastic material, such as a rubber-elastically deformable material. It should be noted that the main body 12 of the battery cell closure strip 10 has a circumferential connection surface 34, which serves for the gas-tight attachment of the pouch-shaped or prismatic battery cell housing to the battery cell closure strip 10. This can be achieved by welding, gluing, or other means familiar to those skilled in the art.

In FIG. 2, an enlarged detail portion of the exposed battery cell closure strip 10 is shown in the region of the degassing duct 22. The main body 12 has a seal retaining structure 36 for the sealing element 26 in the form of a recess, which is circular in the present example. The recess is circumferentially bounded by a wall 38. The wall 38 can form a circumferential shoulder 40 that serves as a sealing surface for the sealing element 26.

In FIG. 3, the sealing element 26 is shown in the mounted state. The sealing element 26 has a sealing lip 42, which is circumferential in the present example, which, in regular operation of the battery cell strip 10, sealingly abuts against the sealing surface in a pretensioned manner in an axial direction with respect to the longitudinal axis L of the recess. The sealing element 26 may have a projection 44, with which it is supported on the main body 12 in an axial direction with respect to the longitudinal axis L. The inner inlet 46 and the outer outlet 48 of the degassing duct 22 can be clearly seen. It should be noted that the longitudinal axis L of the recess is arranged to extend orthogonally with respect to the vertical axis V of the battery cell closure strip 10. As a result, a sufficiently compact design for the presently relevant battery cells can be realized with the battery closure strip 10.

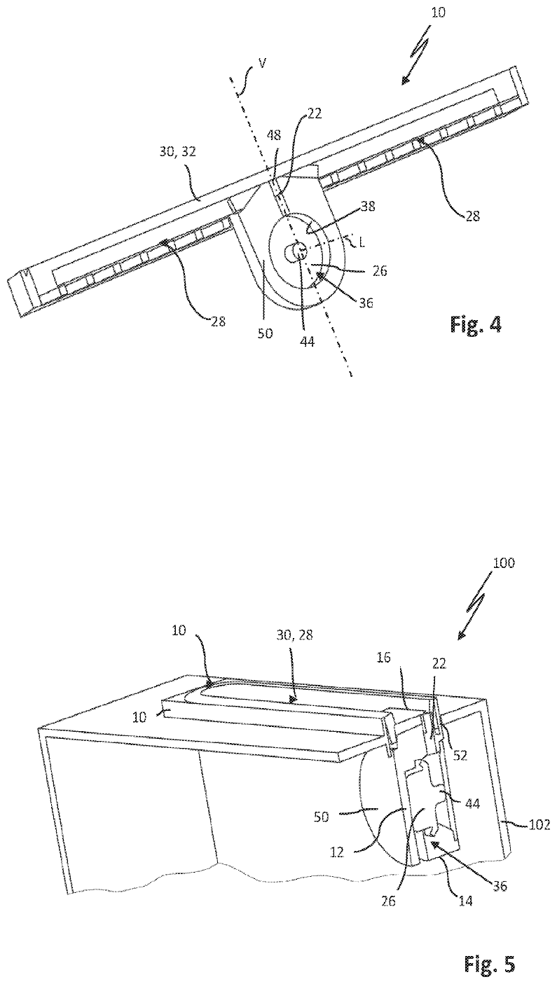

In FIGS. 4 and 5, another exemplary embodiment of a battery cell closure strip 10 is shown, which differs from the exemplary embodiment explained above in connection with FIGS. 1 to 3 explained above substantially in the geometric position of the sealing element 26 relative to the bursting valve 30. In this case, the seal retaining structure 36 is formed on an extension 50 of the main body 12 that extends away from the rest of the main body 12 in an axial direction with respect to the vertical axis V of the battery cell closure strip 10. Thus, the sealing element 26 and the bursting valve 30 of the emergency degassing duct 28 are spaced apart from each other in the direction of the vertical axis V and are arranged one above the other.

FIG. 5 shows a battery cell 100 with the battery cell closure strip 10. The battery cell 100 has a (generally) prismatic housing shape. In particular, the battery cell closure strip 10 may be welded to the rest of the housing 102 of the battery cell 100. The bursting cap 32 may be arranged on a retaining flange 52 of the main body 12 and may surround the latter—preferably on both sides—circumferentially.

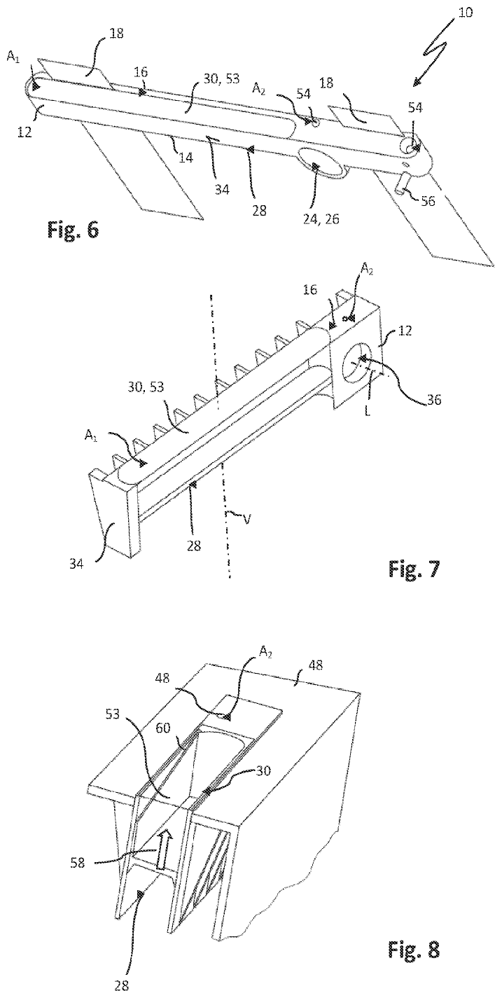

FIGS. 6 and 7 each show further battery cell closure strips 10 in which the emergency degassing duct 28 includes a bursting valve 30 having a bursting membrane 53. The bursting membrane may be made of a plastic material, metal or composite material. The bursting membrane offers the advantage of a particularly inexpensive and compact design. The opening cross section A1 of the emergency degassing duct 28 and the significantly smaller opening cross section A2 of the degassing duct 22 can be clearly seen.

According to the exemplary embodiment shown in FIG. 6, in all embodiments explained herein, the battery cell closure strip 10 can comprise a filling opening 54 for filling the battery cell, which opening can be closed by means of a closure element 56, in particular in the form of a cylindrical plug, which is preferably displaceably mounted on the battery cell closure strip 10. According to the exemplary embodiment shown in FIG. 6, the terminals 18 may be fixedly connected to the main body 12 and form a jointly handled structural unit therewith. Referring to FIG. 7, the seal retaining structure 36 and the sealing element 26 disposed therein may be disposed at the edge of the battery cell closure strip 10.

If the battery cell closure strip 10 has a bursting membrane 53, then, according to FIG. 8, a pneumatically actuated (=media-operated) cutting element or a media-operated cutting piston 58 can be movably mounted in the emergency degassing duct 28, by means of which the bursting membrane can be mechanically perforated when the battery cell closure strip 10 is in use and when the predefined (=nominal) bursting pressure Pₘₐₓ is reached or exceeded. The cutting piston has a cutting edge 60 associated with the bursting membrane 53. This can further improve the response behavior of the bursting valve 30.

The main body 12 of the battery cell closure strip 10 above can in principle be made of a plastic material, in particular a thermoplastic material, or metal, in particular aluminum.

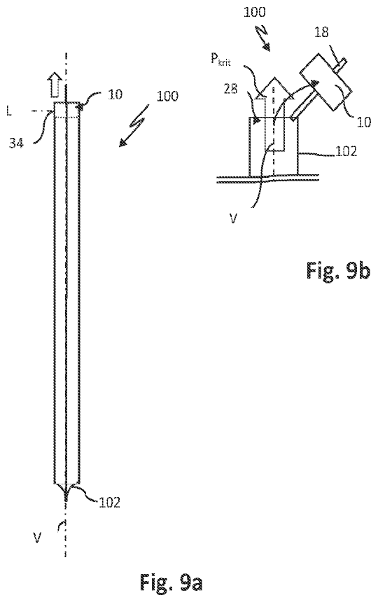

FIG. 9a shows a pouch battery cell 100 with a further battery cell closure strip 10 for a better explanation. The battery cell closure strip 10 may, for example, be embodied according to any of the embodiments according to FIGS. 1 to 8. The pouch-shaped housing 102 is attached to the circumferential connection surface 34 of the main body 12 of the battery cell closure strip 10, in particular welded or bonded thereto. The main body 12 may include a degassing duct and an emergency degassing duct in a manner corresponding to the preceding embodiments.

In the embodiment shown in this case, however, the battery cell closure strip does not have an integrated emergency degassing duct. Reaching or exceeding the bursting pressure P_{crit}, where P_{crit}>Pₗᵢₘ, in the battery cell 100 causes, according to FIG. 9b, a preferably complete separation, in particular ejection, of the battery cell closure strip 10 from the rest of the pouch housing 102 with formation of an emergency degassing duct 28 which, in operation, is open upwards in the direction of the vertical axis V and via which emergency degassing of the battery cell 102 is provided.

What is claimed is:

1. A battery cell closure strip for a battery cell of pouch-type design, comprising:
a main body having:
a degassing duct which extends along the vertical axis V of the battery cell closure strip from an inner side to an outer side thereof, wherein the degassing duct is closed during normal operation of the battery cell closure strip by means of a media-operated sealing element which opens the degassing duct when a predefined internal limit pressure Pₗᵢₘ is reached; and
having an emergency degassing duct which has an opening cross section through which media can flow that is at least 10 times larger than that of the degassing duct, and which is closed by means of a bursting valve which opens the emergency degassing duct when a nominal internal bursting pressure P_{crit}, where P_{crit}>Pₗᵢₘ, is reached or exceeded;
wherein the bursting valve comprises a bursting membrane.

2. The battery cell closure strip of claim 1, wherein the bursting valve comprises a bursting cap.

3. The battery cell closure strip of claim 2, wherein the bursting cap consists of a rubber-elastically deformable material.

4. The battery cell closure strip of claim 1, wherein the bursting cap is arranged on a retaining flange of the main body and surrounds the latter circumferentially.

5. The battery cell closure strip of claim 1, wherein the bursting valve comprises a cutting element which is movably mounted on the main body and by means of which the bursting membrane can be perforated when the nominal internal bursting pressure Pₘₐₓ is reached or exceeded.

6. The battery cell closure strip of claims, wherein the sealing element has a circumferential, sealing lip which, in its sealing position closing the degassing duct, sealingly abuts against a sealing surface of the main body and which can be moved into an open position, in which it opens the degassing duct and in which the sealing lip is arranged at least in portions at a distance from the sealing surface.

7. The battery cell closure strip of claim 1, wherein the sealing element is arranged and retained in a seal-retaining structure of the main body in the form of a recess.

8. The battery cell closure strip of claim 7, wherein the seal retaining structure is formed on an extension of the main body which extends away from the rest of the main body in a direction, which is axial with respect to the vertical axis V of the battery cell closure strip.

9. The battery cell closure strip of claim 7, wherein the recess extends transversely to the vertical axis V of the battery cell closure strip.

10. The battery cell closure strip of claim 1, wherein the battery cell closure strip comprises the terminals of the battery cell or comprises through recesses for the terminals of the battery cell.

11. The battery cell closure strip of claim 1, wherein the battery cell closure strip has a filling opening for the battery cell, which opening can be closed by means of a closure element which is mounted displaceably on the main body.

12. The battery cell closure strip of claim 1, wherein the main body is made of a plastic material, in particular a thermoplastic material, or metal, in particular aluminum.

13. A battery cell of pouch-type design for a traction battery of an electric vehicle, wherein a housing of the battery cell comprises the battery cell closure strip of claim 1.
